(19) United States
(12) Patent Application Publication
(10) Pub. No.: US 2003/0037054 A1
(43) Pub. Date: Feb. 20, 2003

(54) Method for controlling access to medical information

(75) Inventors: Rabindranath Dutta, Austin, TX (US); Kumar Ravi, Cedar Park, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/925,782

(22) Filed: Aug. 9, 2001

(51) Int. Cl. G06F 17/30

(52) U.S. Cl. 707/100

(57) ABSTRACT

A system and a method for controlling access to patient medical information through a networked aggregate medical server are provided. Patient medical information is received at the server. Patient access instructions are received at the server. An access request for medical information is received at the server from a requester. Correspondence with the access request and the patient access instructions is determined. A portion of the medical information is sent to the requestor based on the patient access instructions if the access request and the patient instructions correspond.

### BACKGROUND OF THE INVENTION

1. Related Applications

This application incorporates by reference co-pending U.S. patent application entitled “Method For Providing Medical Financial Information” (AUS920010240US1), assigned to International Business Machines, Incorporated filed on ______.

2. Field of Invention

The present invention generally relates to a method for a networked aggregate medical server for managing access to patient medical information.

3. Description of Related Art

Presently patients have very limited control over the dissemination of their medical information to healthcare providers, insurance companies, employers, credit bureaus and third party advertisers. Although a release for this information may be required by law, often the expiration of such releases are not honored. Moreover, the information obtained is not deleted from the requesting agency's database. Further, patients' information may be used in clinical trials, demographic profiling, market research programs and to obtain unique identification markers by government agencies. The patient may be wholly unaware of these requests as these may be facilitated by blanket requests for information incorporated in insurance, employment and credit applications.

When made aware of the release of this information, the patient may have great difficulty tracing the various requesters to withdraw the medical release. This is a function of the limited documentation required to request the information and the relaxation of restrictions that would require additional input from the patient. It would be desirable to have a method whereby patients could control access to their medical records by third parties.

Another shortfall of the present means for managing patient medical records is that they comprise many different formats, i.e. x-rays, EKG's, MRI's, clinical records, accounting data, etc. that must be associated, catalogued and stored. The volume and complexity may lead to errors in the treatment or billing of the patient as there exists a potential to misdirect records to the wrong patient. Presently a patient is afforded no means to review and annotate the database to reflect apparent discrepancies. Typically, the only means available for annotating the database is by informing the healthcare provider, who may or may not coordinate this information to other parties involved with the patient, such as, insurers, pharmacists, therapists, etc. This poses a potential for the record being inaccurate and bearing the potential for misdiagnosis, misdirected treatment protocols and billing inaccuracies. Another shortcoming of the present method of managing patient medical records is that the patient is seldom permitted to review the record and verify its accuracy. Furthermore, responses formulated by the patient as to their progress or untoward effects of treatment are not incorporated into the medical record. This lack of information most directly negatively impacts the clinician's approach to treating the patient. It would be advantageous to have a system whereby the patient could verify and annotate his or her medical records.

The need to secure the medical records of a patient continues to be a paramount concern. Several systems exist that provide security of the medical data employing various cryptographic mechanisms to prevent the unauthorized access to data however, these do not allow the patient to modify a requester's access. Some systems further restrict direct access to the patient of his or her own medical data and require that access be afforded via a third party. It would be desirable to have a system that overcomes the above disadvantage.

Another aspect of the present security measures to safeguard medical data is that the information necessary for certain healthcare providers to treat the patient may be unavailable to them. This may be a function of the format of the data, the platform that supports the data, software constraints and various communication requirements. These elements create a system that lacks portability and which presents transparent restrictions to healthcare networks and insurers not recognized by the system despite obtaining authorization from the patient. Further, the medical data is not always available in a real-time manner as a manual release authorization must be obtained and subsequently it must be input to allow transmission to the requesting party. This untimely delay may give rise to grave circumstances when the patient requires emergency treatment and is unable to completely and effectively relate his or her medical history. It would be desirable to have a system that would overcome the above and other disadvantages.

### SUMMARY OF THE INVENTION

The present invention relates to a method for a networked aggregate medical server for managing access to patient medical records. Various aspects of the invention are novel, non-obvious and provide various advantages. While the actual nature of the present invention covered herein can only be determined with reference to the claims appended hereto, certain features, which are characteristic of the embodiments disclosed herein, are briefly described as follows.

One aspect of the invention provides a method of controlling access to patient medical information through a networked connection. The patient medical information is received at an aggregate medical server. The patient access instructions are received at the aggregate medical server. An access request is received from a requester at the aggregate medical server. The correspondence between the access request and the patient access instructions is determined. Based on the patient access instructions and the access request a portion of the patient medical information is sent to the requestor if the patient access instructions correspond with the access request.

Another aspect of the invention provides for a computer usable medium, generally an aggregate medical server storing a program for controlling access to patient medical information through a networked connection. Computer readable code is provided to receive patient medical information, receive patient access instructions, receive an access request from a requestor, determine whether the access request corresponds with the patient access instructions and send a portion of the patient medical information to the requestor based upon correspondence between the patient access instructions and access request.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a system for a networked aggregate medical server for restricting access to patient medical information in accordance with the invention;

FIG. 2A is a block diagram of one embodiment of an aggregated medical server for restricting access to patient information, in accordance with the invention;

FIG. 2B, FIG. 2C, FIG. 2D and FIG. 2E are examples of database tables for the operation of one embodiment of the networked aggregate medical server shown in FIG. 2A for restricting access to patient information, in accordance with the invention; and

FIG. 3A and FIG. 3B are flowcharts of one embodiment of a routine for restricting access to patient medical information, in accordance with the invention.

### DETAILED DESCRIPTION OF THE PRESENTLY PREFERRED EMBODIMENTS

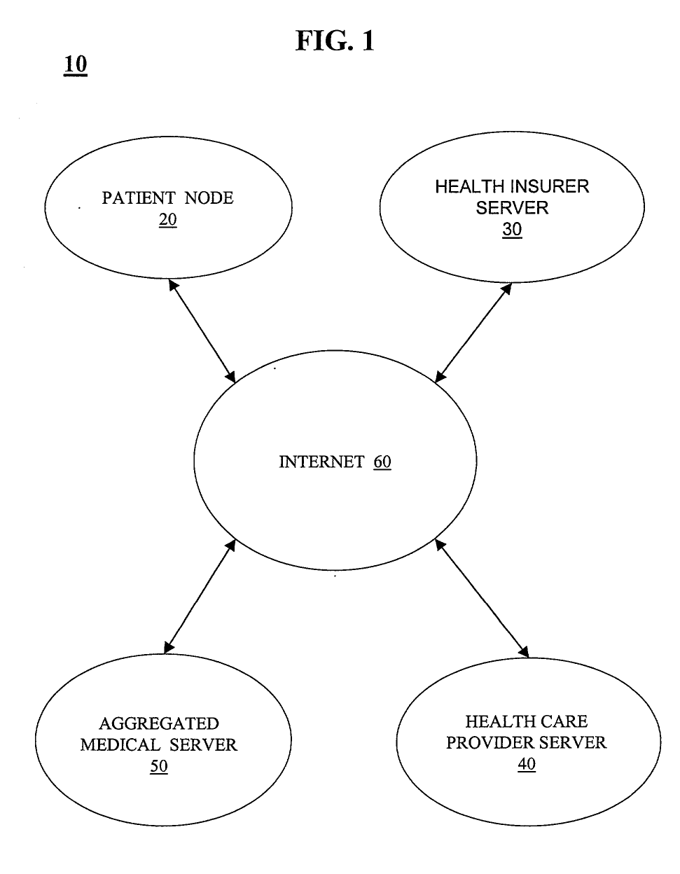

FIG. 1 illustrates one embodiment of a system for a networked aggregate medical server for restricting access to patient medical information in accordance with the present invention.

Referring to FIG. 1 one embodiment of a system for a networked aggregate medical server restricting access to patient medical information is generally shown at numeral 10. The patient medical information may for example be comprised of laboratory reports, clinical findings, physicians' notes, insurance billing data, x-rays, dental records, patient identification data and insurance provider data. The network aggregate medical server system 10 may include a patient node 20, a health insurer node 30, a health care provider server 40, an aggregated medical server 50 and Internet 60. In another embodiment the system 10 may be any of a local area network, an intranet or a virtual private network. The system 10 may receive patient instructions to restrict access to the patient medical information via the Internet 60 from the patient node 20. The patient node 20 may utilize any personal computer, personal digital assistant, digital telephone or any device capable of communicating over the Internet 60 known in the art to generate instructions to restrict access to patient medical information. The patient node 20 may be operably connected to the Internet 60. The Internet 60 may route any number of digital signals to any of a plurality of server site addresses via various telecommunication means over the World Wide Web. Any commercially available Internet Service Provider (ISP) known in the art providing access to the World Wide Web, may access the Internet 60. The Internet 60 may receive and direct the patient instructions to restrict access to patient medical information to the aggregated medical server 50.

In another embodiment, the system 10 may receive requests for patient medical information from the patient via the Internet 60 from the patient node 20. The patient node 20 may be any personal computer, personal digital assistant, digital telephone or any device capable of communicating over the Internet 60 known in the art to receive requests for patient medical information. The patient node 20 may be operably connected to the Internet 60. The Internet 60 for receiving and directing requests for patient medical information to the aggregated medical server 50. The Internet 60 subsequently may receive and direct patient medical information to the patient node 20 from the aggregated medical server 50.

The system 10 may receive requests for patient medical information from the various healthcare insurers and employers via the Internet 60 from the health insurer server 30. The health insurer server 30 may be any computer server capable of routing digital signals to any other computer via the Internet 60, intranet, local area network or any other network using various telecommunications means, known in the art to send and receive requests for patient information. The health insurer server 30 may be operably connected to the Internet 60. The Internet 60 for receiving and directing requests for patient medical information to the aggregated medical server 50. The Internet 60 subsequently may receive and direct patient medical information to the health insurer server 30 from the aggregated medical server 50.

The system 10 may receive requests for patient medical information from the various healthcare providers including physicians, pharmacists, allied health professionals, hospitals and treatment centers via the Internet 60 from the healthcare provider server 40. The healthcare provider server 40 may be any computer server capable of routing digital signals to any other computer via the Internet 60, intranet, local area network or any other network using various telecommunications means, known in the art to send and receive requests for patient information. The healthcare provider server 40 may be operably connected to the Internet 60. The Internet 60 may receive and direct requests for patient medical information to the aggregated medical server 50. The Internet 60 subsequently may receive and direct patient medical information to the healthcare provider server 40 from the aggregated medical server 50.

The system 10 may process requests for patient medical information and transmit patient medical information from a medical records clearinghouse via the Internet 60 from the aggregated medical server 50. The aggregated medical server 50 may be any commercially available computer server capable of providing secure transactions over the Internet 60 via any hardware and/or software methods known in the art. The aggregated medical server 50 may be operably connected to the Internet 60.

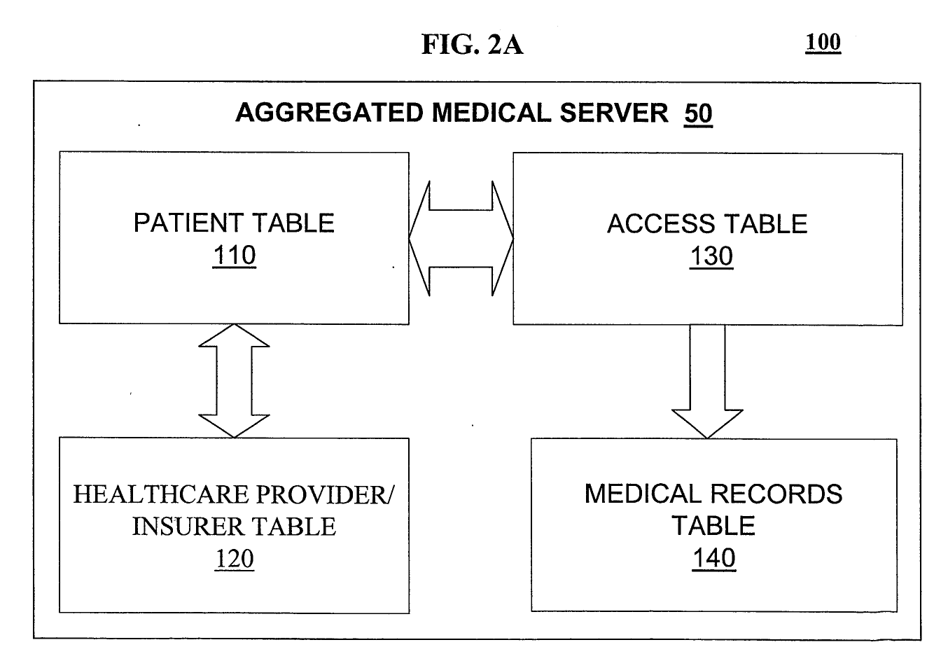

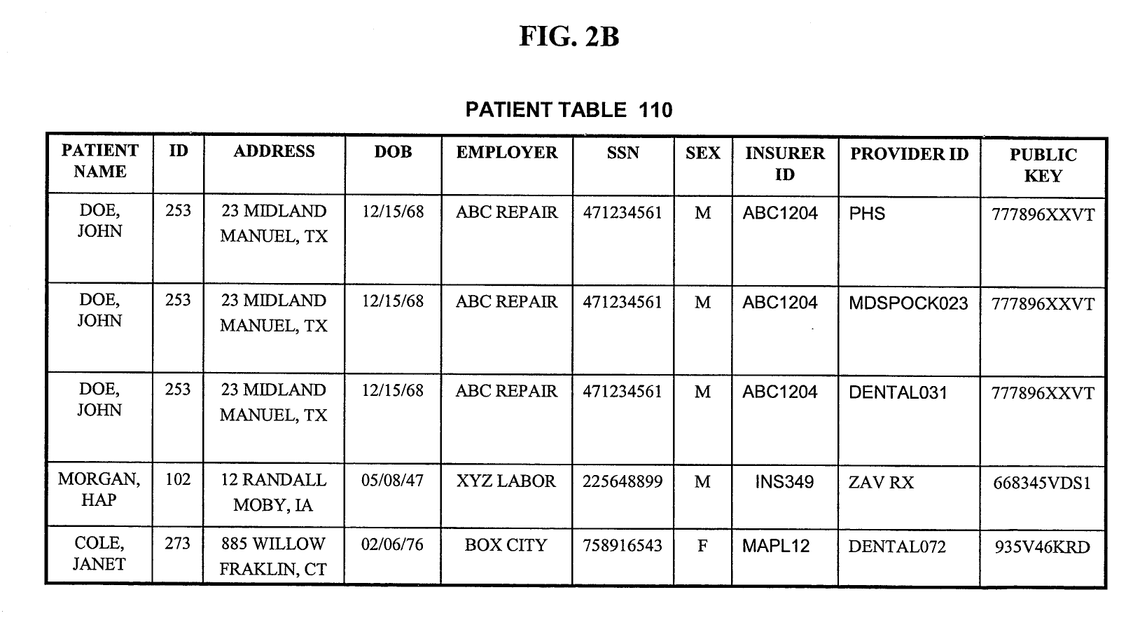

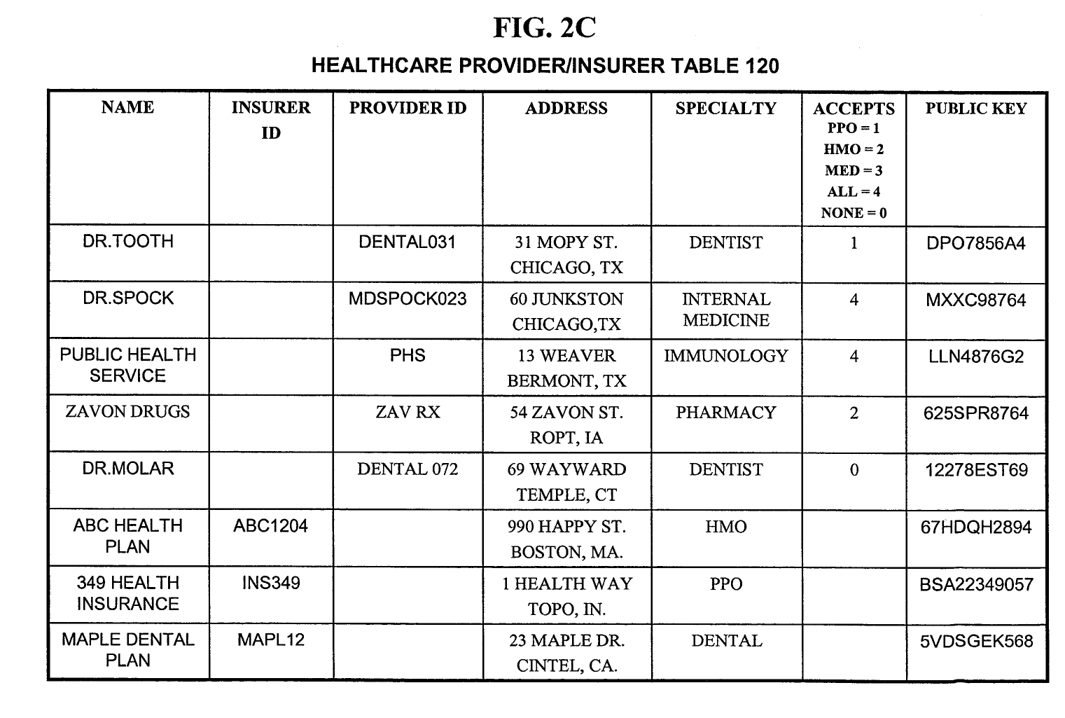

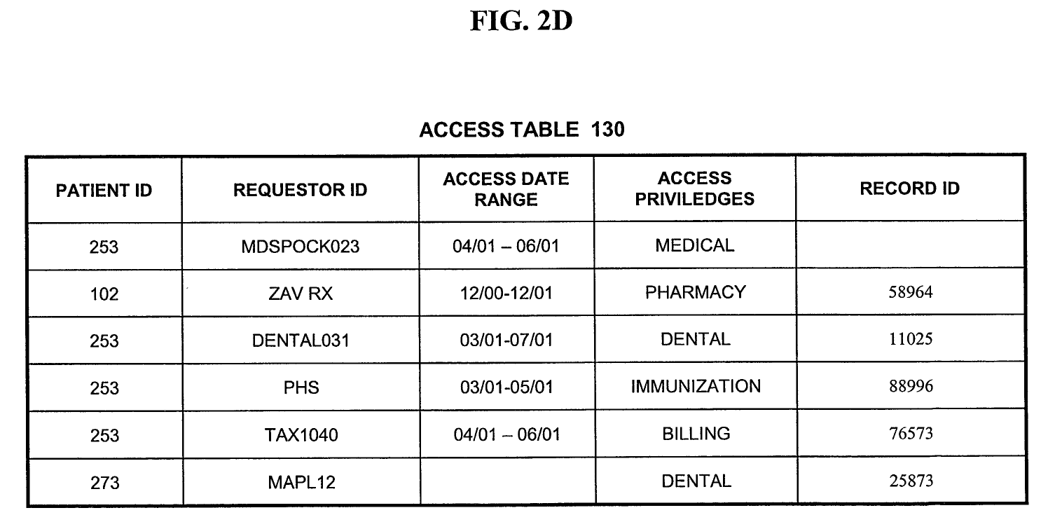

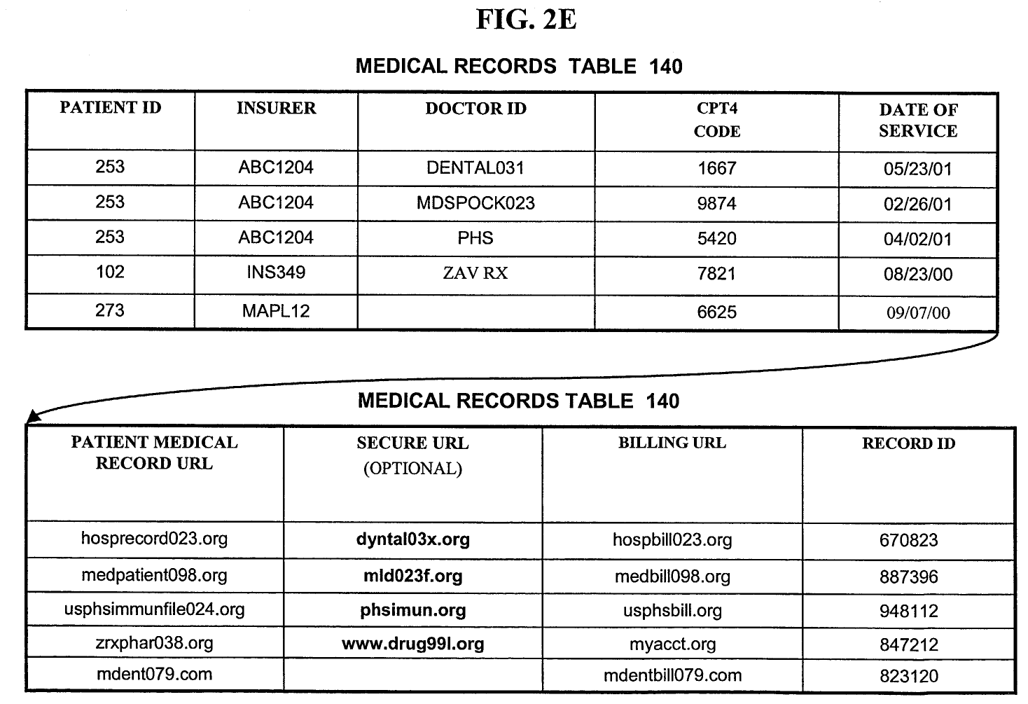

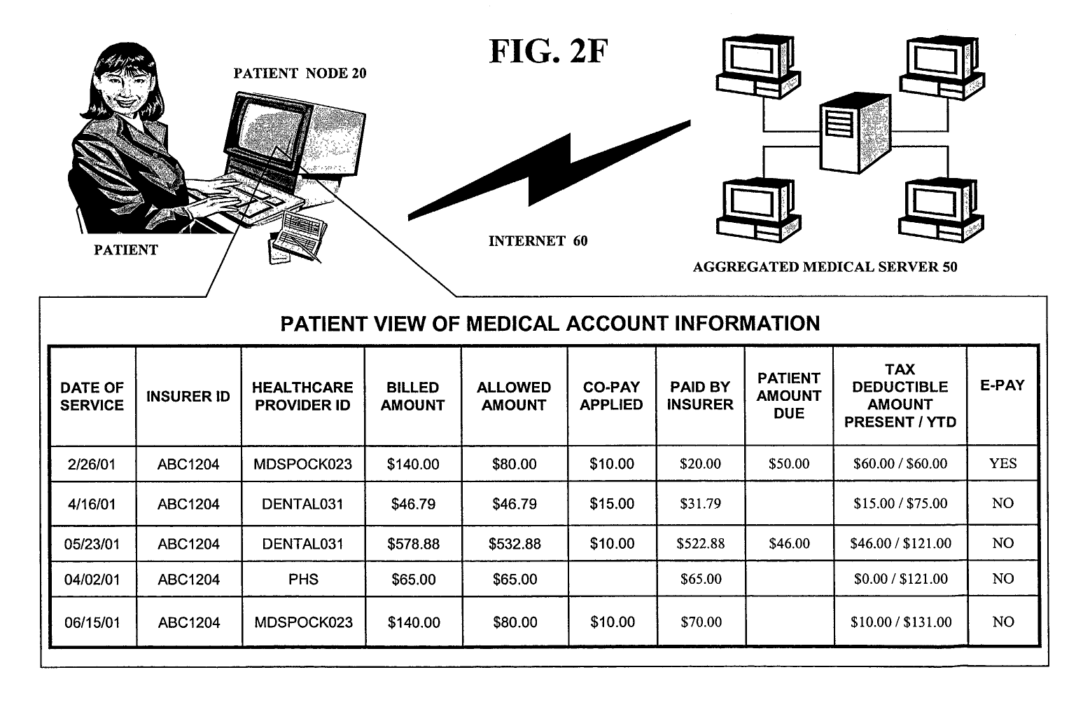

FIG. 2A illustrates one embodiment of a system for a networked aggregate medical server for restricting access to patient medical information, in accordance with the present invention.

FIG. 2B, FIG. 2C, FIG. 2D and FIG. 2E illustrate database tables for the operation of one embodiment of the networked aggregate medical server shown in FIG. 2A for restricting access to patient medical information, in accordance with the present invention.

Referring to FIG. 2A one embodiment of aQsystem for an aggregate medical server 50 for restricting access to patient medical information is generally shown at numeral 100. The aggregate medical server system 100 may include a patient table 110 shown in FIG. 2B, a healthcare provider/insurer table 120 shown in FIG. 2C, an access table 130 shown in FIG. 2D and a medical records table 140 shown in FIG. 2E stored on an aggregated medical server 50. In another embodiment the aggregated medical server 50 may store tables for patient access instructions, healthcare provider access, healthcare insurance access, patient account data and medical information. The aggregated medical server 50 may secure transactional data using extensible mark-up language, (XML), public key cryptography to secure medical information. In another embodiment the tables may contain data objects that may be used to associate medical records, patient information, billing data, healthcare provider data, server site addresses, physical location identification data for permanent hardcopy files or other elements as required to facilitate association written in extensible mark-up language, (XML) as further described in Extensible Mark-up Language 1.0 W3C Recommendation Oct. 6, 2000 [http://www.w3.org/TR/REC-xml]. These data objects may be well formed parsed entities containing root entities, which may be composed of properly nested declarations, elements, comments, character references, processing instructions and references to other entities. These entities may be accessed by any combination of public key, digital signature, password or other cryptographic means known in the art, which satisfy any validity constraint, well formedness constraint or reference requirement nested in the processing instructions. In another embodiment the entity may be further encrypted and secured by converting the entity by any encryption algorithm in combination with any public key, digital signature, password or other cryptographic means known in the art to render a non-valid entity incapable of being read by any validating or non-validating XML processors. Examples of the XML entities for Medical Record are shown below in Table 1.0.

TABLE 1.0
Examples of XML Entities

EXAMPLE 1
<Medical Record>

<Patient ID>

<Date>

<Physician>

<Symptoms> </Symptoms>
<Diagnosis>

<Tests>

<Blood Tests Results>

<Blood Test URL> </Blood Test_URL>

</Blood Test Results>
<X-Ray>

<X-Ray URL> </X-Ray URL>

</X-Ray>

</Tests>
<Doctor's comments> </Doctor's comments>

</Diagnosis>
<Treatment>

<Prescription>

<Drug number>

| | |
|---|---|
| <Drug name> | </Drug name> |
| <Quantity> | </Quantity> |
| <Dosage> | </Dosage> |
| <Generic Allowed> | </Generic Allowed> |
| <Number of Refills> | </Number of Refills> |

</Drug number>

</Prescription>
<Future course of treatment>
</Future course of treatment>

</Treatment>

</Physician>

</Date>

</Patient ID>

</Medical Record>
EXAMPLE 2
<Medical Record>

<Patient ID>

<Date>

<Immunization>

<Provider Name> </Provider Name>
<Immunization received> </Immunization received>

</Immunization>

</Date>

</Patient ID>

</Medical Record>

The aggregated medical server 50 may receive patient instructions to restrict patient medical information via the Internet 60 from the patient node 20. The aggregate medical server 50 may store the patient instructions to restrict patient medical information in an access table 130. The aggregate medical server 50 may receive requests for patient medical information and accounting data via the Internet 60 from the patient node 20, the health insurer server 30 and the healthcare provider server 40. The aggregate medical server 50 may store the healthcare provider and health insurer data in a healthcare provider/health insurer table 120. In another embodiment the aggregate medical server 50 may have a separate healthcare provider table and a health insurer table. In another embodiment the aggregated medical server 50 may permit healthcare providers and health insurance providers to input data into the patient medical records table 140 via the access table 130. Where correlation exists between the patient data and access instructions stored in patient table 110 the healthcare provider/health insurer access table 120 and the access table 130 the aggregate medical server 50 may permit access to the medical records table 140 using any matching techniques known in the art for assembling correlation tables. Subsequently, the aggregate medical server 50 may obtain authentication of a requestor's public key from a third party certificate authority such as VeriSign®.

In another embodiment, the aggregate medical server 50 may use a public key to provide access to the a portion of the patient medical table 140 to the requesting party by passing decryption data and protocols to the patient medical table 140 by any means known in the art. Subsequently, the aggregate medical server 50 may transmit the encrypted patient medical information to the patient, healthcare provider or the health insurer via the Internet 60 to the patient node 20, to the health insurer server 30 or the healthcare provider server 40. In another embodiment, the aggregate medical server 50 may receive instructions from the patient to annotate a portion of the patient medical information using XML to make comments regarding veracity of the data, treatment progress or adverse responses via the Internet 60 from the patient node 20. The aggregate medical server 50 may further generate alerts to designated healthcare providers based on the comments made in the patient medical record where the medical server 50 transmits an alert via the Internet 60 to the healthcare provider server 40.

An example of one embodiment is generally shown in the patient access table 110 where John Doe, a patient may be provided an identification number 253 associated with other unique patient identifiers such as social security number, date of birth, address or other data that may be used for this purpose. The patient, John Doe identified as patient ID 253 in this example, may have a public key 777896XXVT obtained from any third party certificate authority know in the art that issues digital certificates (i.e.VeriSign®), however, a password or digital signature may be substituted. The patient subsequently may then select which healthcare providers, insurers and other third parties that may have access to his medical records, the length of authorization and level of access. One embodiment of inputs is illustrated in the access table 130. In table 130 John Doe, patient ID 253 has provided medical access to his medical records to MDSPOCK023 for the period of 4/01 to 6/01. The access table 130 also shows that patient 253 has also granted billing access to TAX1040 and restricted access to DENTAL031 and PHS each having different access date ranges. In another embodiment, the access table 130 may restrict the selection of patient medical information using the record ID in lieu of the access date range. The access table 130 in this embodiment may give precedence to the record ID when both the record ID and access date are both available. Any of the healthcare providers identified by patient 253 may review his medical record in accordance with the restrictions expressed in the access table 130. For example Dr. Tooth may decide to review Mr. Doe's medical history prior to performing a root canal. Dr. Tooth may transmit a request for patient medical information using his public key to the aggregate medical server 50 via the Internet 60 from the healthcare provider server 40. The aggregate medical server 50 may receive the request from the healthcare provider server 40 via the Internet 60 and may verify the requester using public key cryptography or other means known in the art. Subsequently, the medical server 50 may correlate the request against the healthcare provider/insurer table 120, where Dr. Tooth may be identified as DENTAL031 and may be subsequently correlated against the access table 130. Upon corresponding Dr. Tooth's ID with the access instructions provided by the patient in the access table 130, access may be granted to the medical records table 140. The medical records table then may access only the patient's dental records for the period from 3/01 to 7/01 and subsequently, may transmit these records in an encrypted state to the requestor. In one embodiment, a URL containing the address of the encrypted files may then be generated and transmitted to the requester. In another embodiment, the URL may be secure. In this example, Dr. Tooth may not receive any medical data beyond dental records, in order to obtain the required information Dr. Tooth may request that the patient provide him access by providing new access instructions to the aggregated medical server 50.

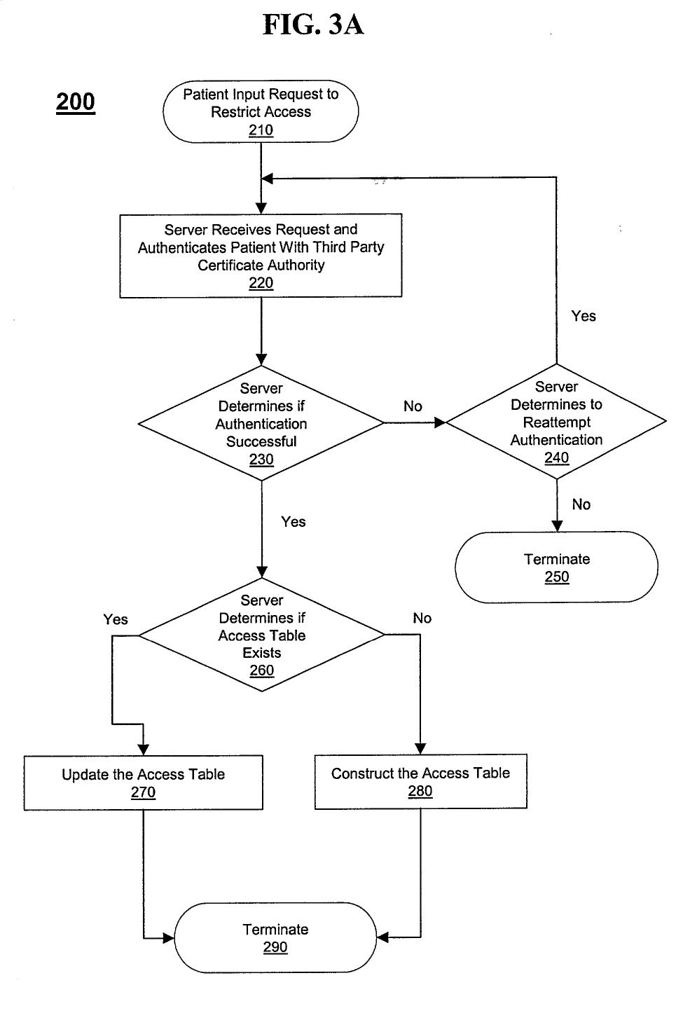

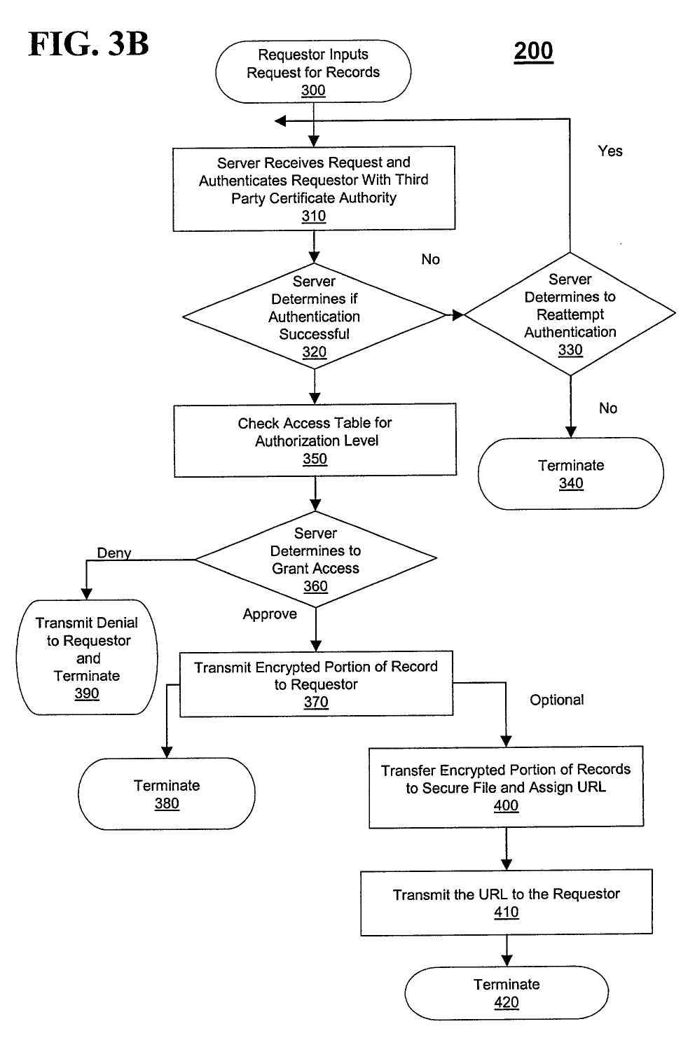

FIG. 3A and FIG. 3B illustrates one embodiment of a routine for a networked aggregate medical server for restricting access to patient medical information in accordance with the present invention.

Referring to FIG. 3A and FIG. 3B one routine of a method for a networked aggregate medical server 50 is generally shown at numeral 200. A patient may input instructions to restrict medical information where the patient node 20 may transmit the instructions over the internet 60 to the aggregated medical server 50 (Block 210). The aggregated medical server 50 may receive a patient request to restrict medical information and may subsequently authenticate the patient request by verification of the patient's public key or digital certificate with a third party certificate authority (Block 220). In another embodiment, the patient may log on to the medical server 50 using a user ID and a password. The aggregated medical server 50 may then determine if a patient authentication is successful (Block 230). If the patient authentication fails, the medical server 50 may determine to reattempt patient authentication (Block 240). The medical server 50 may make an affirmative determination to repeat the authentication of the patient repeating (Block 220). The medical server 50 may make a negative determination to terminate the patient authentication and routine (Block 250). Subsequent to authenticating the patient request the aggregated medical server 50 may determine if an access table 130 exists (Block 260). Subsequent to an affirmative determination, the medical server 50 may update the access table 130 with the patient's instructions (Block 270). The medical server 50 may then terminate the routine (Block 290). If the medical server 50 determines that no access table 130 exists, then the medical server 50 may construct an access table 130 (Block 280). Subsequently, the medical server 50 may terminate the routine (Block 290). In another embodiment, the aggregated medical server 50 may then locate all the patient's medical records and synchronize the encryption of all located files.

A requestor consisting of at least one member of a group containing the patient, health insurer, healthcare provider and an interested third party may request patient medical information. The patient may input a request for patient medical information. This request may be received at the medical server 50 where the patient node 20 may transmit the request via the Internet 60 to the aggregated medical server 50 (Block 300). The health insurer or third party may input a request for patient medical information. This request may be received at the medical server 50 where the health insurer server 30 may transmit the request via the Internet 60 to the aggregated medical server 50 (Block 300). The healthcare provider may input a request for patient medical information. This request may be received at the medical server 50 where the Healthcare provider server 40 may transmit the request via the Internet 60 to the aggregated medical server 50 (Block 300). The aggregated medical server 50 may receive the request for patient medical information and may then authenticate the request by verifying the requestor's public key or digital certificate with a third party certificate authority (Block 310). In another embodiment, the requestor may log on to the medical server 50 using a user ID and password. The aggregate medical server 50 may then determine if a requestor authentication is successful (Block 320). If the requestor authentication fails, the aggregate medical server 50 may determine to re-attempt requestor authentication (Block 330). The medical server 50 may make an affirmative determination to repeat the requestor authentication repeating (Block 310). The medical server 50 may make a negative determination to terminate the requestor authentication and routine (Block 340). Subsequent to authenticating the request for medical information, the aggregated medical server 50 may correlate the patient table 110, healthcare provider/health insurer table 120, and the access table 130 for authorization levels (Block 350). The medical server 50 may then determine whether to grant or deny access (Block 360). If access is denied, the aggregate medical server 50 may terminate the routine and may communicate the denial to the requestor where the aggregate medical server may transmit the request via the Internet 60 to the healthcare provider server 40 or the health insurer server 30 depending on the originator of the request (Block 390). Subsequent to the granting access, the aggregated medical server 50 may then encrypt and transmit the designated portion of the patient medical records to the requestor (Block 370). The aggregated medical server 50 may then terminate the operation (Block 380). In another embodiment the aggregated medical server 50 may then transfer a copy of the encrypted portion of the record to a secure URL for the requestor to access (Block 400). The aggregated medical server 50 may then transmit the secure URL to the requester where the aggregated medical server 50 may transmit the URL via the Internet 60 to the patient node 20, the healthcare provider server 40 or the health insurer server 30 depending on the originator of the request (Block 410). The aggregated medical server 50 may then terminate the routine (Block 420).

The aggregate medical server 50 may distribute any of the operations described in the routine generally shown in FIG. 3A and FIG. 3B at numeral 200 to a health insurer server 30 and a healthcare provider server 40. The medical server 50 may coordinate the operations of the health insurer server 30 and healthcare provider server 40 over the Internet 60, necessary to execute the routine. The medical server 50 may delegate implementation of any feature shown in the routine to the health insurer server 30 and healthcare provider server 40. The medical server 50 may assign a hierarchical rank to the distributed servers performing the routine operations.

While the embodiments of the invention disclosed herein are presently considered to be preferred, various changes and modifications may be made without departing from the spirit and scope of the invention. The scope of the invention is indicated in the appended claims, and all changes that come within the meaning and range of equivalents are intended to be embraced therein.

1. A method of controlling access to patient medical information through a networked connection comprising:
receiving patient medical information at an aggregate medical server;
receiving patient access instructions at the aggregate medical server;
receiving an access request from a requester at the aggregate medical server;
determining whether the access request corresponds with the patient access instructions; and
sending a portion of the patient medical information to the requester based on the patient access instructions and the access request if the patient access instructions corresponds with the access request.

2. The method of claim 1 wherein the patient access instructions include alert instructions.

3. The method of claim 2 further comprising:
generating alerts over the network to any of a healthcare provider, a patient, a treatment facility or a government agency subsequent to receiving adverse medical data.

4. The method of claim 1 further comprising:
providing a hyperlink to the aggregate server wherein the hyperlink comprises the access request.

5. The method of claim 4 wherein the hyperlink is provided on a web site for access by the requester.

6. The method of claim 1 wherein determining whether the access request corresponds with the patient access instructions further comprises implementing at least one security feature.

7. The method of claim 6 wherein the security feature is selected from a group consisting of a user password, a public key cryptograph, a digital signature, and an XML based security standard.

8. The method of claim 1 further comprising:
verifying a portion of the patient medical information with an outside server.

9. The method of claim 8 wherein verifying the portion of the patient medical information comprises determining a patient eligibility.

10. The method of claim 1 further comprising:
updating the patient medical information.

11. The method of claim 1 wherein the patient medical information is selected from a group consisting of a name, a social security number, a plan number, personal information, medical history information, medical claims information, prescription information, insurance company information, billing information, healthcare provider information, record ID, date of service and CPT4 code.

12. The method of claim 1 wherein the access information comprises level authorization information.

13. The method of claim 12 wherein level authorization comprises restriction to a patient medical information category.

14. The method of claim 13 wherein the patient medical information category is selected from a group consisting of laboratory services, healthcare providers, pharmacy services and diagnostic services.

15. A computer usable medium including a program for controlling access to patient medical information through a networked connection comprising:
computer readable program code for receiving patient medical information at an aggregate medical server;
computer readable program code for receiving patient access instructions at the aggregate medical server;
computer readable program code for receiving an access request from a requestor at the aggregate medical server;
computer readable program code for determining whether the access request corresponds with the patient access instructions; and
computer readable program code for sending a portion of the patient medical information to the requester based on the patient access instructions and the access request if the patient access instructions corresponds with the access request.

16. The computer usable medium of claim 15 wherein the patient access instruction includes an alert instruction.

17. The computer usable medium of claim 16 further comprising:
computer readable code for generating alerts over the network to any of a healthcare provider, a patient, a treatment facility or a government agency subsequent to receiving adverse medical data.

18. The computer usable medium of claim 15 further comprising:
computer readable code for providing a hyperlink to the aggregate server wherein the hyperlink comprises the access request.

19. The computer usable medium of claim 18 wherein the hyperlink is provided on a web site for access by the requester.

20. The computer usable medium of claim 15 wherein the computer readable code for determining whether the access request corresponds with the patient access instructions comprises computer readable code for implementing security features.

21. The computer usable medium of claim 20 wherein the security feature is selected from a group consisting of: a user password, a public key cryptograph, a digital signature, and an XML based security standard.

22. The computer usable medium of claim 15 further comprising:
computer readable code for verifying a portion of the patient medical information with an outside server.

23. The computer usable medium of claim 22 wherein the computer readable code for verifying the portion of the patient medical information comprises computer readable code for determining a patient's eligibility.

24. The computer usable medium of claim 15 further comprising:
computer readable code for updating the patient medical information.

25. The computer usable medium of claim 15 wherein the patient medical information is selected from a group consisting of: a name, a social security number, a plan number, personal information, medical history information, medical claims information, prescription information, insurance company information, billing information, and health provider information.

26. The computer usable medium of claim 15 wherein the access information comprises level authorization information.

27. A system for controlling access to patient medical information through a networked connection comprising:
means for receiving patient medical information at an aggregate medical server;
means for receiving patient access instructions at the aggregate medical server;
means for receiving a request from a requester at the aggregate medical server;
means for determining whether the access request corresponds with the patient access instructions; and
means for sending a portion of the patient medical information to the requestor based on the access instructions and the access request if the patient access instructions corresponds with the access request.
